(19) United States
(12) Patent Application Publication
(10) Pub. No.: US 2016/0379024 A1
(43) Pub. Date: Dec. 29, 2016

(54) Apparatus, System and Method for Tracking Agricultural Grain

(71) Applicant: INTELLIFARM, INC., Lincoln, NE (US)

(72) Inventors: Steve R. Tippery, Gretna, NE (US); Larry L. Tippery, Blair, NE (US); Heath Roehr, Lincoln, NE (US)

(21) Appl. No.: 15/192,997

(22) Filed: Jun. 24, 2016

Related U.S. Application Data
(60) Provisional application No. 62/184,169, filed on Jun. 24, 2015.
(60) Provisional application No. 62/192,445, filed on Jul. 14, 2015.

(51) Int. Cl. G06K 7/10; G06F 17/30

(52) U.S. Cl. CPC G06K 7/10366; G06F 17/30312

(57) ABSTRACT

A radio frequency pill for tracking grain or other agricultural products through an agricultural value chain includes a body. The body has an outer surface shaped substantially the same as a selected seed type. The body further includes a cavity. A radio frequency identification device (RFID) is disposed within the cavity of the body. The RFID device is encoded with identification information readable by a remotely positioned reader.

### CROSS-REFERENCE TO RELATED APPLICATION

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

The present application constitutes a regular (non-provisional) patent application of U.S. Provisional Patent Application entitled METHOD AND SYSTEM FOR TRACKING AGRICULTURAL GRAIN, naming Steve R. Tippery and Heath Roehr as inventors, filed Jun. 24, 2015, Application Ser. No. 62/184,169, which is incorporated herein by reference in the entirety.

The present application constitutes a regular (non-provisional) patent application of U.S. Provisional Patent Application entitled METHOD AND SYSTEM FOR TRACKING AGRICULTURAL GRAIN, naming Steve R. Tippery and Larry Tippery as inventors, filed Jul. 14, 2015, Application Ser. No. 62/192,445, which is incorporated herein by reference in the entirety.

### TECHNICAL FIELD

The present invention generally relates to tracking agricultural products, and, more particularly, to tracking agricultural grain through the value chain with radio frequency tracking capabilities.

### BACKGROUND

Agricultural crops grown across the world are commodities which become mixed together as they move throughout the agricultural value chain. Due to contamination, disease, viruses, and bacteria, the ability to track individual lots of grain back to their original sources is desirable. Few traceability solutions currently exist. One current approach includes tracing grain by tracking an individual truck or train. However, once the grain is dumped into the next value chain holding device, the grain is co-mingled with grain from other sources and all traceability is lost. Therefore, it would be desirable to provide a method and system that cure the shortfalls of the previous approaches identified above.

### SUMMARY

A pill assembly for tracking grain is disclosed, in accordance with one or more illustrative embodiments of the present disclosure. In one illustrative embodiment, the pill assembly includes a body. In another illustrative embodiment, the body has an outer surface shaped substantially the same as a selected seed type and includes a cavity. In another illustrative embodiment, the pill assembly includes a radio frequency identification device (RFID) disposed within the cavity of the body. In another illustrative embodiment, the RFID is encoded with identification information readable by a remotely positioned reader.

A pill assembly for tracking grain is disclosed, in accordance with one or more illustrative embodiments of the present disclosure. In one illustrative embodiment, the pill assembly includes a body. In another illustrative embodiment, the body has an outer surface shaped substantially the same as a selected agricultural product and includes a cavity. In another illustrative embodiment, the pill assembly includes a radio frequency identification device (RFID) disposed within the cavity of the body. In another illustrative embodiment, the RFID is encoded with identification information readable by a remotely positioned reader.

A system for tracking grain is disclosed, in accordance with one or more illustrative embodiments of the present disclosure. In one illustrative embodiment, the system includes a radio frequency (RF) pill dispenser unit. In another illustrative embodiment, the RF pill dispenser unit is configured to dispense a plurality of RF pills into a volume of grain seeds. In another illustrative embodiment, each of the plurality of RF pills includes a radio frequency information device (RFID) encoded with identification information. In another illustrative embodiment, the system includes an RFID reader. In another illustrative embodiment, the RF pill dispenser unit is configured to transport the plurality of RF pills through a region at least proximate to the RFID reader. In another illustrative embodiment, the RFID reader configured to identify at least some of the plurality of RF pills as the RF pills are transported through the region at least proximate to the RFID reader. In another illustrative embodiment, the system includes a data base. In another illustrative embodiment, the system includes a controller communicatively coupled to the RFID reader. In another embodiment, the controller including one or more processors configures to execute a set of program instructions maintained in memory. In another embodiment, the set of program instructions is configured to cause the one or more processors to acquire identification information for a particular RF pill from the RFID reader, acquire time information corresponding to the time of identification of the particular RF pill, receive GPS data corresponding to the geographical location of the RFID reader at the time of identification of the particular RF pill, and store the identification information, the time information and geographical location information in the database.

A composition of matter for tracking grain is disclosed, accordance with one or more illustrative embodiments of the present disclosure. In one illustrative embodiment, the composition of matter includes a plurality of radio frequency (RF) pills RF pills. In another illustrative embodiment, the plurality of RF pills are intermixed with a selected volume of a particulate matter.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIGS. 1A-1C illustrate schematic views of a radio frequency (RF) pill, in accordance with one or more embodiments of the present disclosure.

FIG. 1D illustrates a schematic view of an RF pill with a coating deposited on the pill body, in accordance with one or more embodiments of the present disclosure.

FIGS. 1E-1H illustrate schematic views of a variety of RF pill configurations, in accordance with one or more embodiments of the present disclosure.

FIG. 1I illustrates a schematic view of an agricultural product equipped with an RFID device affixed to the surface of the agricultural product, in accordance with one or more embodiments of the present disclosure.

FIGS. 1J-1K illustrate schematic views of a RF pill equipped with a smart assembly, in accordance with one or more embodiments of the present disclosure.

FIG. 2A illustrates a simplified schematic view of a system for tracking grain through a value chain, in accordance with one or more embodiments of the present disclosure.

FIG. 2B illustrates a dispensing unit including multiple hoppers, in accordance with one or more embodiments of the present disclosure.

FIG. 2C illustrates a block diagram view of system for tracking grain, in accordance with one or more embodiments of the present disclosure.

FIG. 2D illustrates a block diagram view of a system for tracking grain configured in a local mode, in accordance with one or more embodiments of the present disclosure.

FIG. 3A illustrates a process flow diagram depicting a method for tracking grain, in accordance with one or more embodiments of the present disclosure.

FIG. 3B illustrates a process flow diagram illustrating various steps through an agricultural value chain, in accordance with one or more embodiments of the present disclosure.

### DETAILED DESCRIPTION OF THE INVENTION

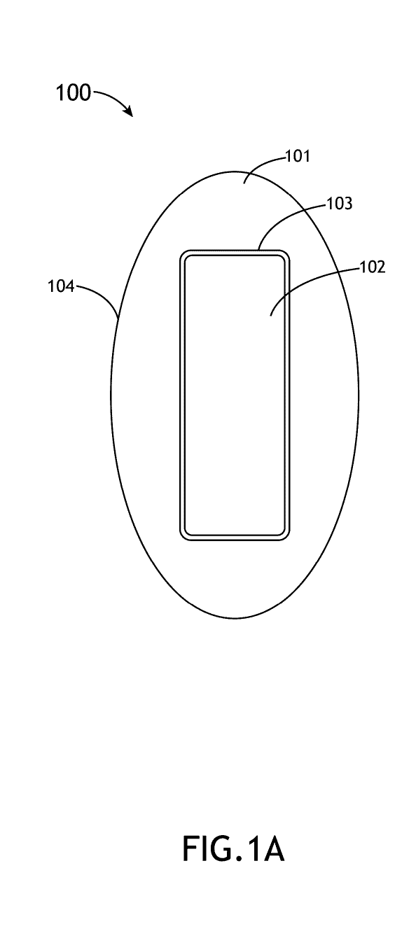

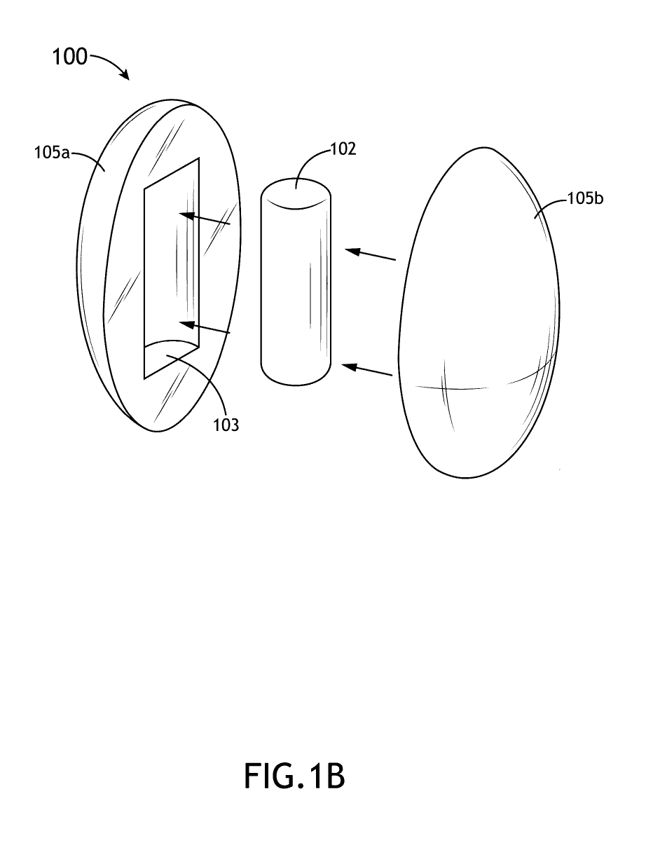

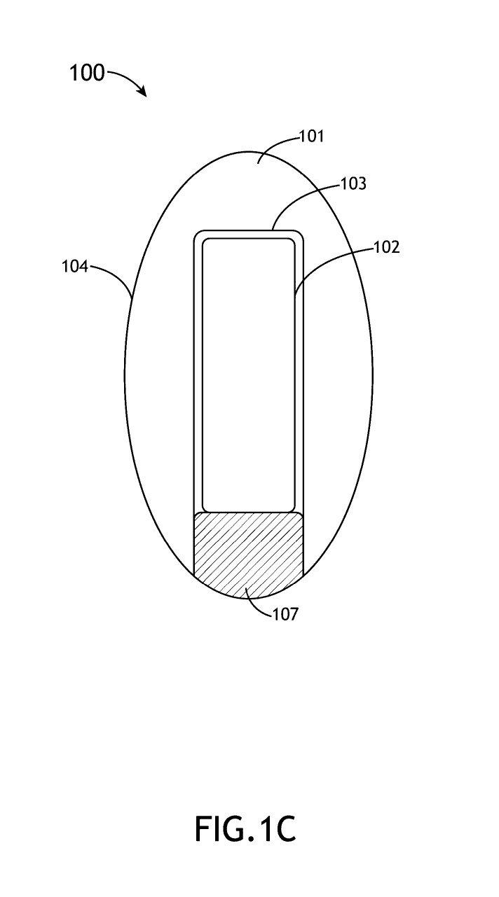

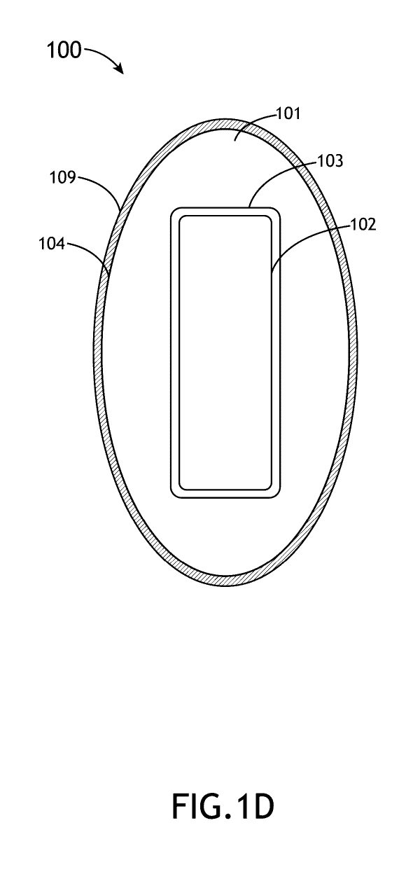

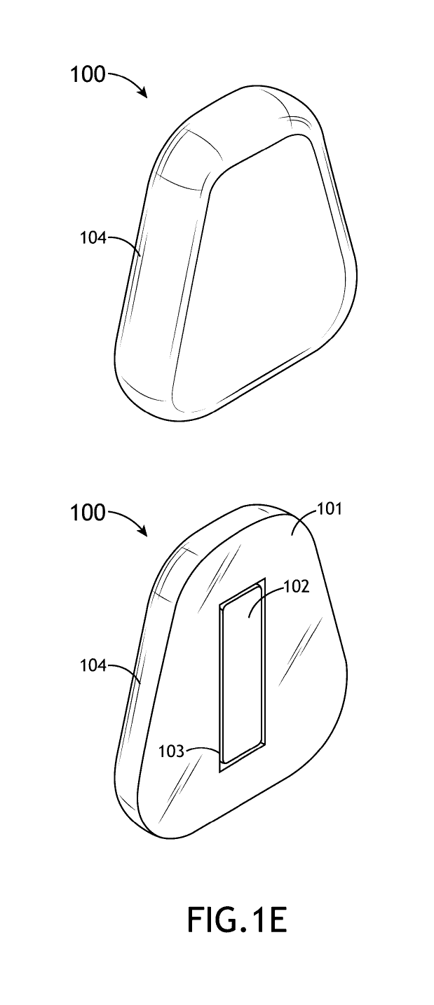

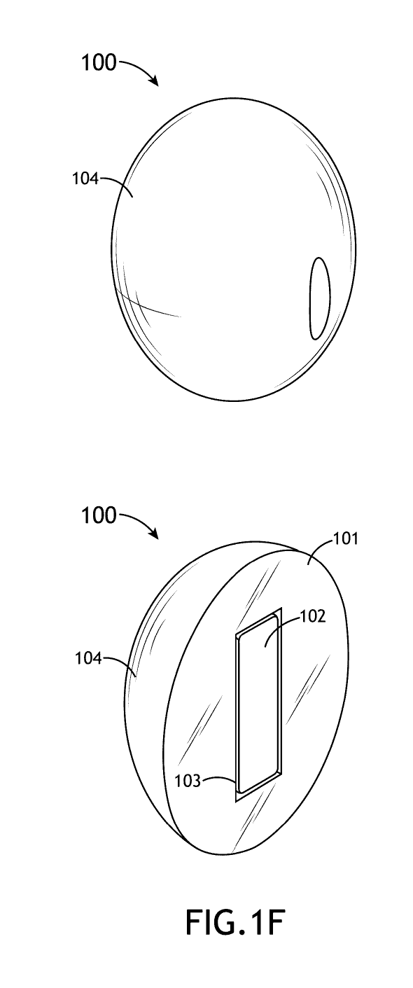

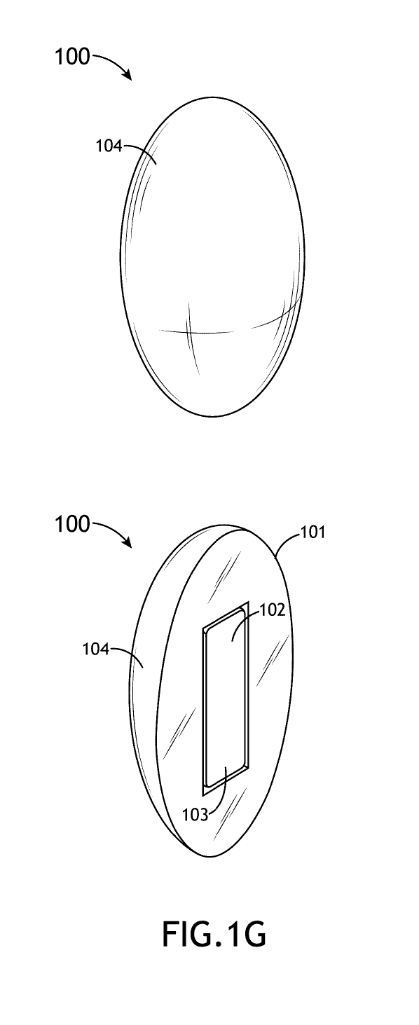

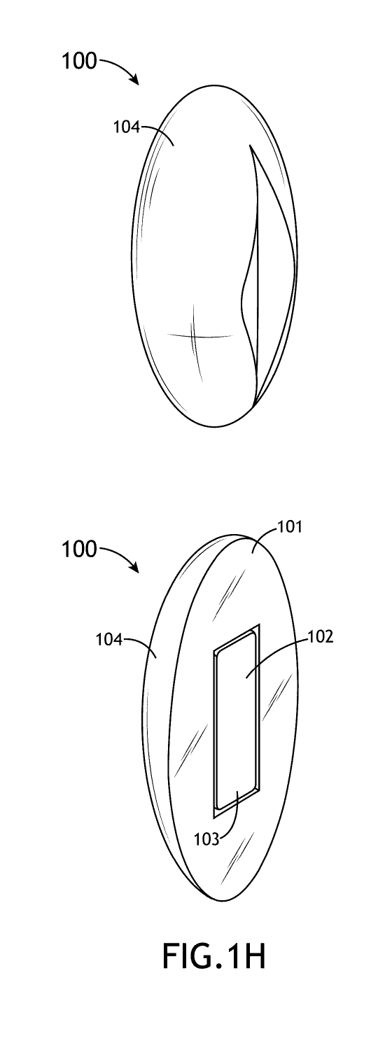

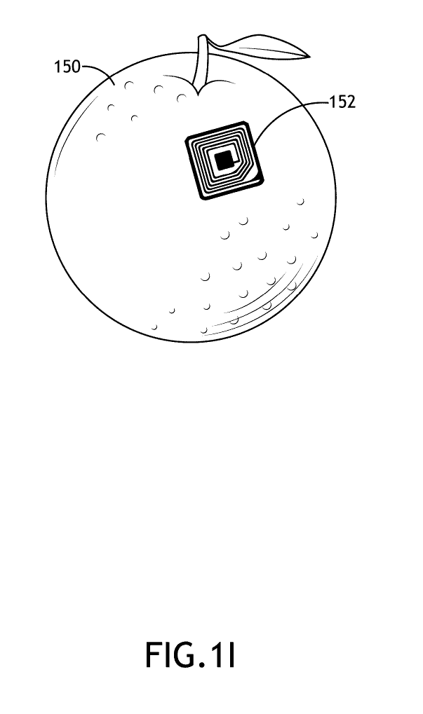

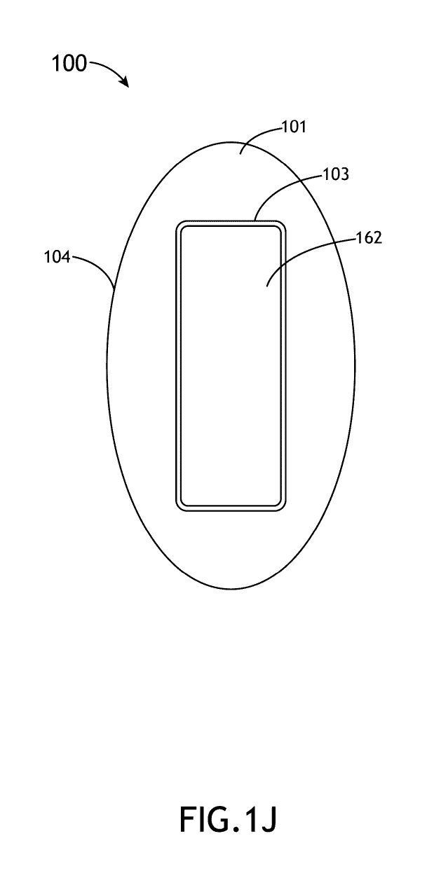

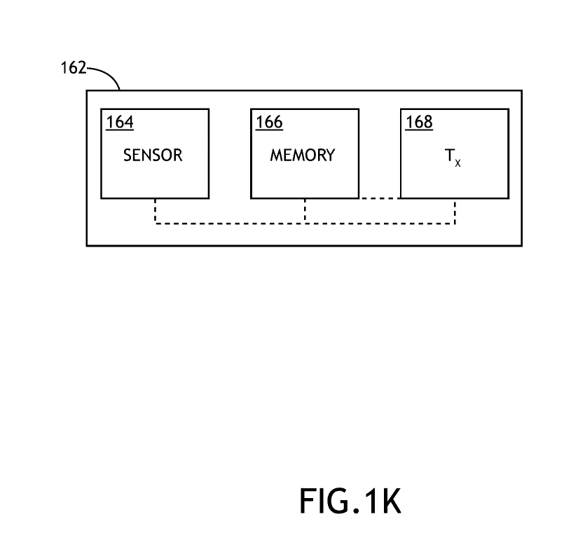

Reference will now be made in detail to the subject matter disclosed, which is illustrated in the accompanying drawings. Referring generally to FIGS. 1A through 4, methods and systems for tracking grain through an agricultural value chain are illustrated, in accordance with one or more embodiments of the present disclosure.

Embodiments of the present disclosure are directed to tracking one or more agricultural products through the agricultural value chain. In some cases, RF pills of the present disclosure are configured as artificial “RF seeds” for tracking agricultural grain through the agricultural value chain associated with the particular grain in question. Embodiments of the present disclosure are directed to one or more radio frequency pills embedded an RFID device and fabricated to have a general shape that substantially matches the shape of a seed grain targeted for tracking. In some embodiments, the shape, size, weight/mass, volume, density, and/or coefficient of friction of the RF pills are such that they fall within a reasonable statistical range for each parameter for the seed grains targeted for tracking.

FIGS. 1A-1B illustrate a radio frequency (RF) pill 100, in accordance with one or more embodiments of the present disclosure. While much of the present disclosure focus on the case where the RF pill 100 takes the form of a seed grain, it is noted that the scope of the present disclosure is not limited to this embodiment. In additional embodiments, the RF pill 100 may take the shape of any agricultural product, such as, but not limited to, one or more food products, such as, but not limited to, potatoes, tomatoes, fruit (e.g., citrus fruit), vegetables and the like.

In one embodiment, the RF pill 100 includes a body 101. The body 101 may be constructed so as to have a shape that is consistent with the particulate matter the RF pill 100 is intended to track. In one embodiment, the body 101 has an outer surface 104 shaped substantially the same as a selected grain type. The body 101 of the RF pill 100 may take on any seed grain shape known in the art of agriculture. For example, as discussed in greater detail further herein, the body 101 of the RF pill 100 may have, but is not limited to, a shape consistent with a kernel of corn, a soybean seed, a rice grain, a wheat grain or the like. In another embodiment, the body 101 of the RF pill 100 includes a cavity 103. In another embodiment, the cavity 103 is shaped and sized so as to contain a radio frequency identification (RFID) device 102.

In one embodiment, the RFID device 102 provides one or more informational characteristics of the associated RF pill 100. For example, the RFID 102 may be encoded with identification information readable by a remotely positioned RFID reader. For example, the RFID 102 may be encoded with a unique identifier (e.g., serial number). In this regard, the RFID 102 may be read by an RFID reader and then dispensed into a volume of seed grain. The identifier contained on an RFID device 102 of a particular RF pill 100 may be associated with the date/time and/or location of dispersal of the particular RF pill 100 into the grain. The identifier, date/time and location may then be stored in a database (e.g., remote cloud-based database or local database) and the RF pill 100 may be tracked at later dates/times and different locations, allowing, for example, a user to identify the source of grain at a particular point in the value chain.

The RF pill 100 may be fabricated utilizing any known fabrication technique. In one embodiment, as shown in FIG. 1A, the RFID device 102 is encapsulated in the body 101 of the RF pill 100. In one embodiment, a molding and/or casting process may be used to form the body 101 around the RF pill 100. For example, an injection molding process may be used to form the body 101 of each RF pill 100 around the corresponding RFID device 102. By way of another example, a solution casting process may be used to form the body 101 of each RF pill 100 around the corresponding RFID device 102. In another embodiment, as shown in FIG. 1B, the pill body 101 may be formed from two or more components 105a, 105b. In this regard, two or more components may be assembled so as to contain the RFID device 102 within the cavity 103. For example, the two or more components 105a, 105b may be affixed to one another utilizing an adhesive compound (e.g., glue, epoxy and the like), a hot press process, or a welding process (e.g., fusion welding, friction welding or sonic welding). In another embodiment, as shown in FIG. 1C, the pill body 101 may be formed (e.g., molded or cast) so as to have a channel extending from the internal cavity 103 to an opening in the outer surface 104. Then, the RFID device 102 may be placed into the cavity through the opening 107. In turn, the RFID device 102 may be sealed into the body 101 using an adhesive compound (e.g., epoxy, clue, and etc), a sealant or a solution cast material (e.g., solution cast plastic).

The one or more RF pills 100 of the present disclosure may be formed using any suitable material. In one embodiment, the body 101 of the one or more RF pills 100 is formed from one or more organic materials. In one embodiment, the body 101 of the one or more RF pills 100 is formed from one or more plastic materials. For example, the body 101 of the one or more RF pills 100 may be, but is not required to be, formed from one or more of the following: polytetrafluoroethylene (PTFE), polyethylene (PE), polyvinyl chloride (PVC), polystyrene, Ketron, Nylon and the like. In another embodiment, the body 101 of the one or more RF pills 100 is formed from one or more rubber materials. In another embodiment, the body 101 of the one or more RF pills 100 is formed from one or more biological materials. For example, the body 101 of the one or more RF pills 100 may be, but is not required to be, formed from one or more of the following: starch-based biological materials or protein-based biological materials. Further, the body 101 of the one or more RF pills 100 may be, but is not required to be, formed from pulp. For instance, the body 101 of the RF pills 100 may be formed by surrounding the RFID device 102 in wood or paper pulp and letting the pulp dry to form a paper-like shell about the RFID device 102.

It is noted that in the case of RF pills 100 formed from biological materials, such RF pills 100 may be consumed throughout the value add food production process. In the event of a food contamination outbreak took place, such an embodiment would provide a mechanism for tracking grain (or other agricultural products) along the agricultural value chain, from the specific field location up to a specific processing plant. This capability allows for very quick identification of the origin of the outbreak/contamination in question.

In another embodiment, the body 101 of the one or more RF pills 100 is formed from graphene. In another embodiment, the body 101 of the one or more RF pills 100 is formed from carbon fiber. In another embodiment, the body 101 of the one or more RF pills 100 is formed from one or more metal materials or metal alloy materials. For example, the body 101 of the one or more RF pills 100 may be, but is not required to be, formed from one or more of the following: aluminum, copper, brass, steel, and the like. In another embodiment, the body 101 of the one or more RF pills 100 is formed from one or more ceramic materials. For example, the body 101 of the one or more RF pills 100 may be, but is not required to be, formed from one or more low temperature ceramic materials.

It is noted that the particular material used to form a given set of RF pills 100 may depend on the type of grain being tracked by the RF pills 100. For instance, it may be desirable to form the body 101 of the RF pill 100 of a material that approximately replicates one or more physical characteristics of the tracked grain in question. For example, the one or more materials used to form the body 101 of the RF pills 100 may be selected such that the RF pills 100 have a mass, volume, density, size, shape, coefficient of friction and the like that is similar to that of the tracked grain in question.

FIG. 1D illustrates an RF pill 100 with a coating 109 deposited on the pill body 101, in accordance with one or more embodiments of the present disclosure. The coating 109 may include any suitable material. For example, the coating material may include, but is not limited to, an organic material, a biological material, a ceramic material or a metal/metal alloy. It is noted that the coating 109 may be particularly useful in establishing a coefficient of friction of the RF pill 100 that approximately matches the seed grain in question. In this regard, a first material may be used form the body 101 in order to generally match the mass/density of the RF pill 100, while the coating 109 is applied to give the RF pill 100 the frictional characteristics that are similar to the tracked seed grain. The coating material may be applied to the pill body 101 in any manner known in the art, such as, but not limited to, casting, spin coating, vapor deposition, spray deposition, dipping and the like.

It is noted that one or more physical characteristics of the RF pill 100 may be determined based on a statistical analysis of one or more characteristics of the tracked grain in question. In one embodiment, the shape and/or size of the RF pill 100 may be determined based on a statistical analysis of the shape and/or size of grain in question. For instance, the shape and/or size of the RF pill 100 may represent a statistical aggregation (e.g., average) of a selected number of grains of the particular grain type in question. In another embodiment, the mass and/or density of the RF pill 100 may be determined based on a statistical analysis of the grain in question. For instance, the mass and/or density of the RF pill 100 may represent a statistical aggregation of the mass and/or density of selected number of grains of the particular grain type in question. In another embodiment, the coefficient of friction of the RF pill 100 may be determined based on a statistical analysis of the grain in question. For instance, the coefficient of friction of the RF pill 100 may represent a statistical aggregation of the coefficient of friction measured from a selected number of grains of the particular grain type in question.

It is noted that matching one or more physical characteristics of the RF pill 100, such as, but not limited to, shape, size, mass, volume, density and/or coefficient of friction to the physical characteristics of the grain type in question may aid in reducing the likelihood of the RF pill(s) 100 from “settling” at locations within a container of the mixture of RF pills 100 and the grain in question. For example, matching one or more of shape, size, mass, volume, density and/or coefficient of friction to the physical characteristics of the grain type in question may aid in reducing the likelihood of the RF pill(s) 100 from settling at the top or bottom of a volume of the grain in question within a container of the mixture of RF pills 100 and the grain in question.

FIGS. 1E-1H illustrate schematic views of a variety of RF pill 100 configurations, in accordance with one or more embodiments of the present disclosure. It is noted that the RF pill 100 may take on any seed grain shape known in the art of agriculture.

In one embodiment, as shown in FIG. 1E, the RF pill 100 has a shape substantially similar to a kernel of corn. In this regard, the outer surface 104 may be shaped to match the shape of a kernel of corn, while the body 101 of the RF pill 100 contains the RFID 102. In one embodiment, as shown in FIG. 1F, the RF pill 100 has a shape substantially similar to a soybean seed. In this regard, the outer surface 104 of the RF pill 100 may be shaped to match the shape of a soybean seed, while the body 101 of the RF pill 100 contains the RFID 102. In one embodiment, as shown in FIG. 1G, the RF pill 100 has a shape substantially similar to a rice seed. In this regard, the outer surface 104 of the RF pill 100 may be shaped to match the shape of a rice seed, while the body 101 of the RF pill 100 contains the RFID 102. In one embodiment, as shown in FIG. 1H, the RF pill 100 has a shape substantially similar to a wheat seed. In this regard, the outer surface 104 of the RF pill 100 may be shaped to match the shape of a wheat seed, while the body 101 of the RF pill 100 contains the RFID 102.

As noted previously herein, the RF pills 100 depicted in FIGS. 1E-1H may also be formed to have shape, size, mass, volume, density and/or coefficient of friction values similar to that of the real grains being tracked by the RF pills 100. Any number of materials may be utilized to match one or more physical characteristics of the real grains. Table I below provides a range of physical characteristic values for corn, soybeans, rice and wheat.

| | Corn | Soybean | Rice | Wheat |
|---|---|---|---|---|
| Density (g/cm³) | 1.27-1.40 | 1.13-1.33 | 1.11-1.46 | 1.29-1.43 |
| Coefficient of | 0.51-0.52 | 0.27-0.55 | 0.68-0.73 | 0.47-0.53 |
| friction | | | | |
| Mass (mg) | 250-350 | 100-200 | 17.5-29.1 | 26-51 |
| Volume (mm³) | 274 | 134-153 | 12-18 | 18.5-28.6 |

Various physical characteristics of corn, soybeans, rice, wheat and other grains are provided by J. M. Boac et al. in Material and Interaction Properties of Selected Grains and Oilseeds for Modeling Discrete Particles, Transactions of the American Society of Agricultural and Biological Engineers, Vol. 53(4): 1201-1216 (2010), which is incorporated herein by reference in the entirety.

By way of example, in the case of corn, a variety of plastics possess the density characteristics suitable for implementation in the one or more RF pills 100 of the present disclosure. For instance, acrylic has a density of 1.2 g/cm3 and may be utilized in the RF pills 100 of the present disclosure. In another instance, nylon has a density between 1.10 and 1.20 g/cm3 and may be utilized in the RF pills 100 of the present disclosure. In another instance, polyurethane and polysulpone have a density between 1.2 and 1.3 g/cm3 and may be utilized in the RF pills 100 of the present disclosure. Further, additional materials may be selected based on other properties such as, but not limited to, coefficient of friction.

It is noted that the above list of materials is by no means a limitation on the scope of the present disclosure is provided merely for illustrative purposes. It is recognized that any material having one or more selected properties similar to a targeted property of the seeds grains that are to be tracked may be used as a material in the fabrication of the RF pills 100 of the present disclosure.

It is again noted that the scope of the present disclosure is not limited to RF pills 100 described in the context of grain seed. In additional embodiments, the RF pill 100 may take the shape of any agricultural product, such as, but not limited to, one or more food products, such as, but not limited to, potatoes, fruit (e.g., citrus fruit, tomatoes and etc.), vegetables and the like.

In additional embodiments, one or more agricultural products 150 may be tracked using an attachable RFID device 152. FIG. 1I illustrates an agricultural product 150 and an attached RFID device 152 affixed to the surface of the agricultural product, in this example an orange. It is noted that the attachable RFID device 152 may be affixed using a machine or manually. Further, it is contemplated herein that the characteristic association and tracking described throughout the present disclosure (see system 200 and method 300) may be extended to the case where the RFID device 152 is affixed to the agricultural product. The one or more agricultural products 150 may extend to any agricultural product known in the art. For example, the one or more agricultural products may include, but are not limited to, one or more food products, such as, but not limited to, vegetables, fruit (e.g., citrus fruit, tomatoes), melons, tubers and the like.

While much of the present disclosure focuses on an RF pill 100 equipped with a passive or active RFID device 102, this should not be interpreted as a limitation on the scope of the present disclosure. It is recognized herein that the artificial seeds and agricultural products of the present disclosure may generally be equipped with any sensing and communication capabilities.

FIGS. 1J-1K illustrate a RF pill 100 equipped with a smart assembly 162, in accordance with one or more embodiments of the present disclosure. In one embodiment, the smart assembly 162 includes one or more sensors 164, memory 166 and/or a transceiver 168 (or dedicated receiver and transmitter). In this regard, identification information may be stored in memory 166 and transmitted to the reader upon interrogation. Alternatively, the smart assembly 162 may also include one or more passive components that provide identification information upon interrogation. In another embodiment, the one or more sensors 164 may measure one or more properties of the RF pill 100 and then store or buffer them in memory 166. Upon interrogation by the reader (e.g., see reader 202 below), the smart assembly may transmit sensor data and/or identification information to the reader 202 via transceiver 168. The one or more sensors 164 may include any sensors known in the art. For example, the one or more sensors 164 may include, but are not limited to, one or more motion sensors (e.g., accelerometers), one or more temperature sensors (e.g., RTD, thermocouple, etc.), one or more light sensors (e.g., diode, CCD, and etc.) and/or one or more moisture sensors.

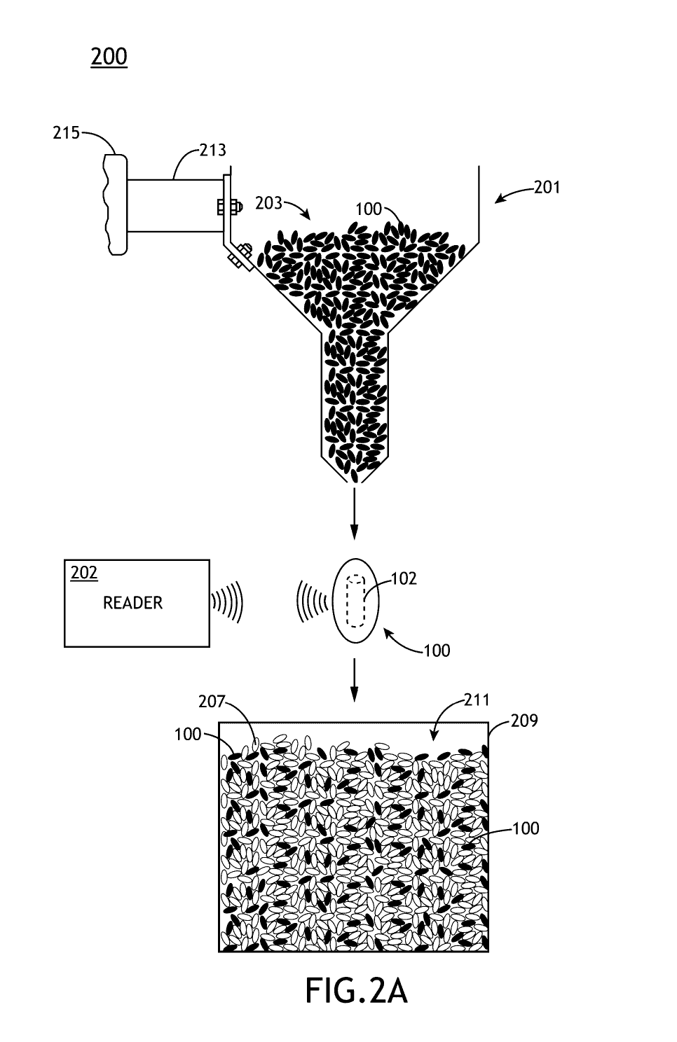

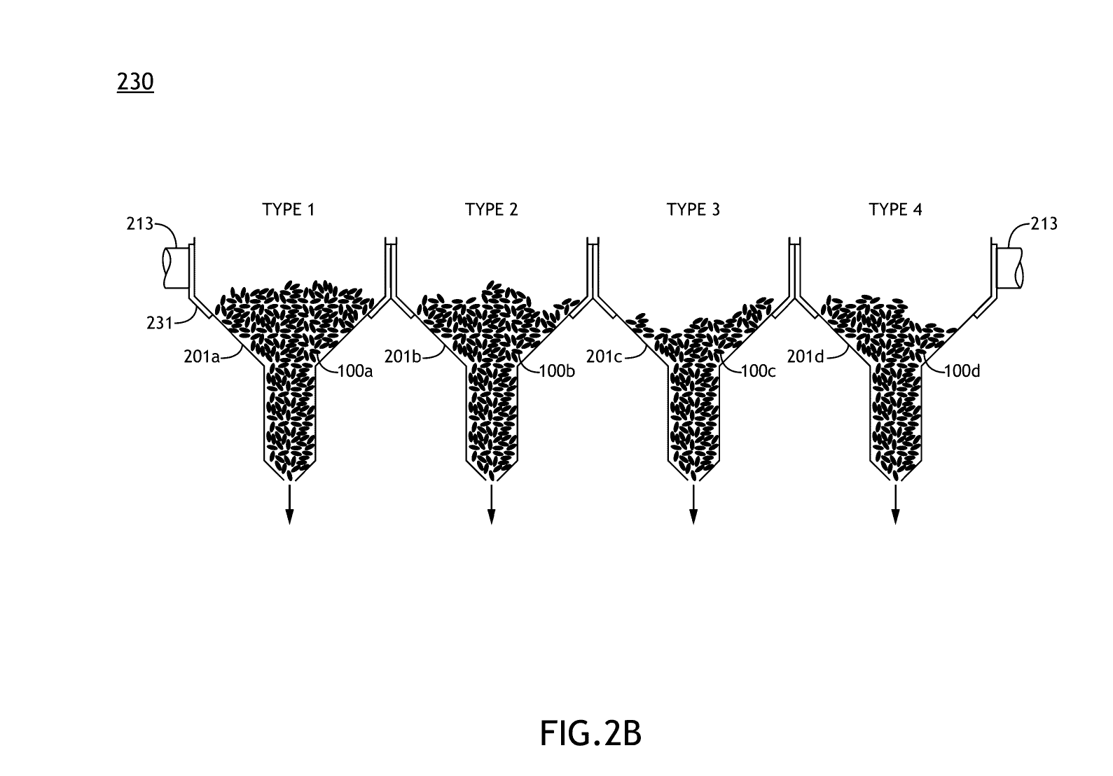

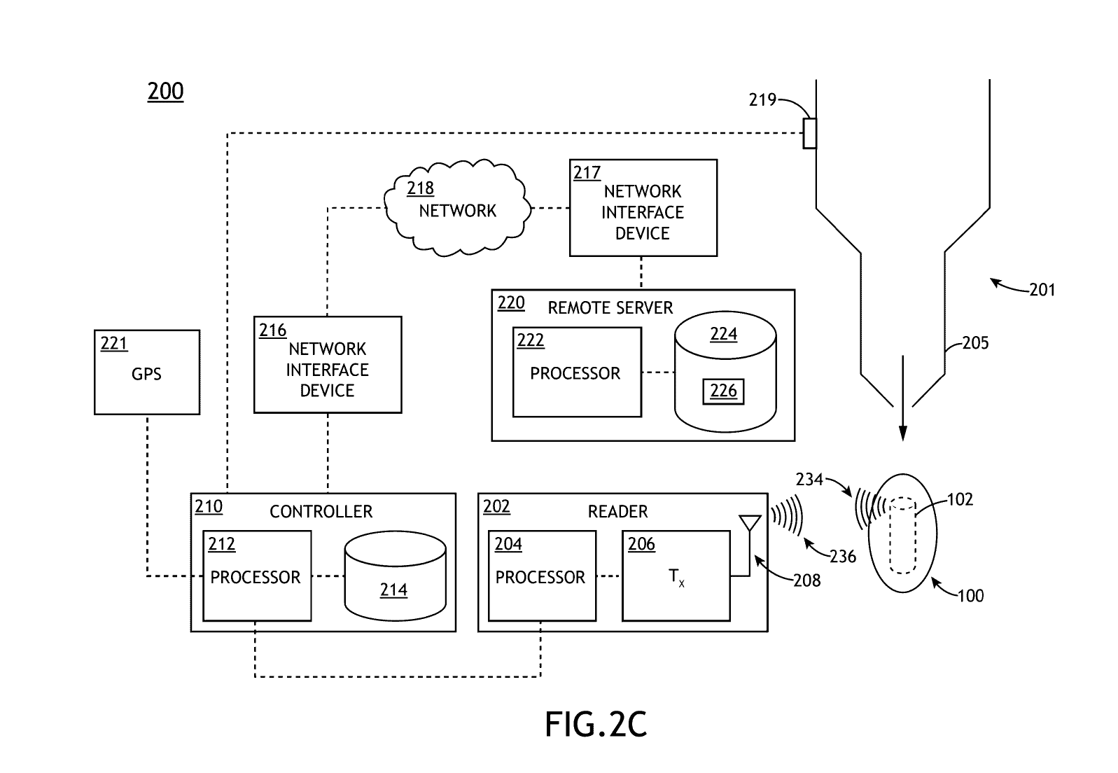

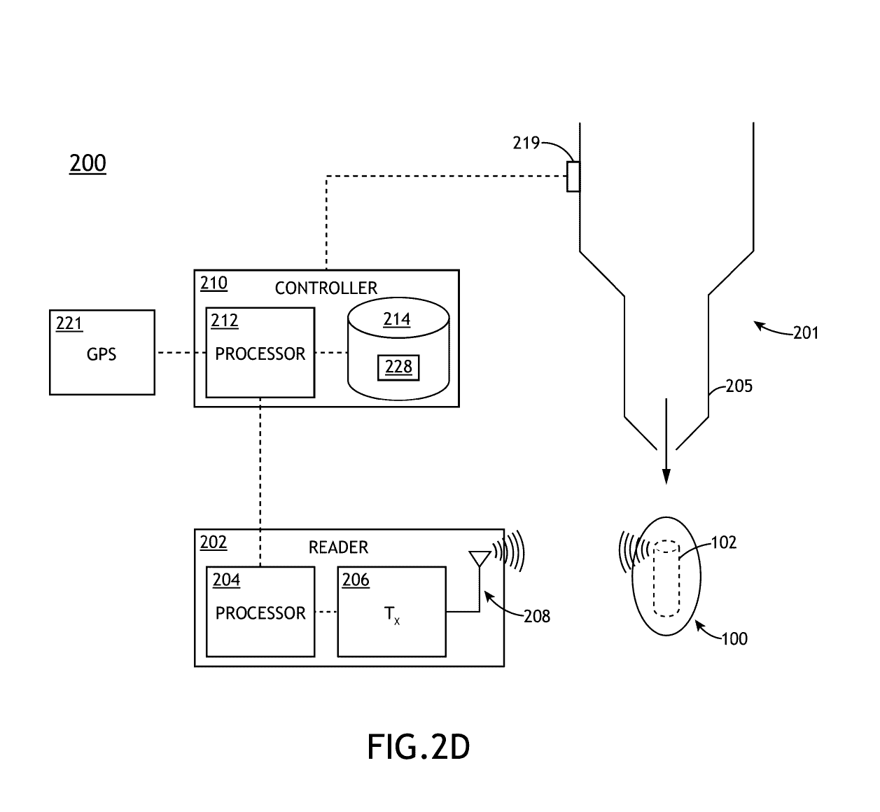

FIG. 2A illustrates a simplified schematic view of a system 200 for tracking grain through a value chain, in accordance with one or more embodiments of the present disclosure.

In one embodiment, the system 200 includes the RF pill dispenser unit 201. In one embodiment, the RF pill dispenser unit 201 includes a hopper, as shown in FIG. 2A. The RF pill dispenser unit 201 is configured to hold a volume of multiple identical RF pills 100. The RF pill dispenser unit 201 may then dispense one or more of the RF pills 100 at selected times or locations as desired. In another embodiment, the system 200 includes one or more RFID readers 202 configured to read one or more information characteristics from the RFIDs 102 contained within the RF pills 100.

In another embodiment, the RF pill dispenser unit 201 is attached to an agricultural machine 215. For example, as shown in FIG. 2A, the RF pill dispenser unit 201 is mechanically coupled to a portion of an agricultural machine 215. In another embodiment, the dispenser unit 201 is reversibly attachable to the agricultural machine 215. For example, the dispenser unit 201 may include a hopper that mounts via a quick-attach device 213 to the agricultural device/machine. In this regard, a first portion of the quick attach device 213 mounts to a portion of the hopper (e.g., base of the hopper), while a second portion of the quick attach device 213 is coupled to the agricultural machine 215.

In another embodiment, the system 200 may be configured so as to lock the operation (e.g., via a controller) of the agricultural device machine 215 (e.g., combine) unless the dispenser unit 201 is mounted on the agricultural machine 215. In this embodiment, once the dispenser unit 201 is attached, the agricultural machine 215 (e.g., combine) may resume its operation (e.g., harvesting operation).

The agricultural machine 215 (shown in part) may include any agricultural machine known in the art of grain planting, harvesting, storage or processing. In another embodiment, the RF pill dispenser unit 201 may dispense RF pills 100 into a selected grain container 209. The grain container 209 may include any grain container known in the art of agriculture, such as, but not limited to, a grain hopper or grain elevator.

In one embodiment, the agricultural machine 215 is a combine (or other harvesting system). In this embodiment, the grain container 209 may include, but is not limited to, a grain hopper. For instance, the RF pill dispenser unit 201 may dispense RF pills 100 into a grain hopper of a combine (or other harvesting unit) during harvesting of the seed grain from one or more fields. In one embodiment, the RF pills 100 may be dropped from the RF pill dispenser unit 201 at periodic intervals so that they pass by or through an RFID reader 202 and into a volume of seed grain. In another embodiment, the RF pills 100 may be periodically dropped from the RF pill dispenser unit 201 as a function of periodic geographical location (e.g., pill periodically dropped after a selected distance of travel of a combine) so that they pass by or through the RFID reader 202 and into a volume of seed grain. In another embodiment, the RF pills 100 may be dropped from the RF pill dispenser unit 201 periodically as function of anticipated volume of harvested grain so that they pass by or through the RFID reader 202 and into a volume of seed grain.

After an RFID pill 100 is dropped by or through the RFID reader 202, the unique identifier associated with the particular RFID pill 100 is stored with date/time and/or geography location information (e.g., GPS data). This information allows the grain that was harvested at that specific time and location (e.g., specific area of the field) to be associated with the particular RFID pill 100, which then travels throughout the grain-RFID pill mixture 211 (mixture of seed grain 207 and RFID pills 100) and makes its way through the value chain (e.g., field, drying bin, storage, processing, market, and etc.). It is noted that each consecutive RFID pill 100 may be deposited in the same manner, traveling together with the seed grain that was harvested in approximately the same time interval throughout the lifetime of the grain.

In one embodiment, the frequency with which RFID pills 100 are dispersed may be used to control the concentration of RFID pills 100 in the mixture of RFID pills 100 and seed grain 207. For example, the frequency of RFID pill dispersal may be varied in relation to the harvested seed volume per unit time (e.g., per minute) to control the RFID pill concentration in the grain-RFID pill mixture 211. The concentration of RFID pills 100 in the mixture 211 may include any concentration suitable for establishing satisfactory statistical information for purposes of tracking the grain 207. For example, the concentration of RFID pills 100 to grains in the mixture 211 may range from approximately 1:10,000,000 to 1:5,000. For instance, in the case of corn, the concentration of RFID pills 100 to grains in the mixture 211 may range from approximately 1:100,000 to 1:20,000. Further, the concentration of RFID pills 100 to corn kernels in the mixture 211 may range from approximately 1:45,000 to 1:35,000. It is noted that this concentration level approximately corresponds to 1-3 kernels of corn per bushel. It is noted that the above concentrations ranges should in no way be considered a limitation on the scope of the present disclosure and are provided merely for illustrative purposes.

In another embodiment, the frequency with which RFID pills 100 are dispersed may be a function of the grain type being tracked. For example, in the case of harvesting a high-yielding corn variety, more RF pills 100 may need to be dispersed into the mixture 211 than would be necessary for the case of a low-yielding soybean variety (due to the significantly higher number of corn seeds relative to soybean seeds per unit of area harvested).

In another embodiment, as the mixture 211 of grain 207 and RFID pills 100 travel throughout the value chain additional readers or other communication devices may read the identification information from the RFID pills. For example, information reading from the RFID pills 100 may occur when the grain-RF pill mixture 211 is moved from one storage device to another. For instance, the RFID pills 100 in the mixture 211 may be read as grain is loaded into or unloaded from a transportation vessel (e.g., train, truck, ship and etc.). In another instance, the RFID pills 100 in the mixture 211 may be read as grain is loaded into or unloaded from a storage unit (e.g., grain bin). As discussed in greater detail further herein, at each location, the information from the RF pills 100 is transferred to a database (e.g., local or remote database) to allow for tracking the location history of the RF pills 100 (and associated grain 207).

While much of the preset disclosure has focused on utilization of the RF pills 100 and system 200 in the context of grain harvesting, it is recognized that the RF pills 100 may be introduced into the agricultural value chain at any stage. For example, RF pills 100 may be distributed in one or more seed containers (e.g., seed bags, seed hoppers and etc.) prior to planting sends in a particular field. For instance, the RF pills 100 may be packaged in seed containers at a packaging plant. As the seed containers move through the value chain, the seed container can be tracked via the RF pills 100 contained in the containers. This tracking allows users to track inventory through the value chain, identify theft, and track which product is sold to which customer, even in the case of later third party sales between multiple customers (i.e. cooperatives, seed dealers, etc.).

Once the seed container is received at the end customer (e.g., farmer) it is possible to utilize one or more readers 202 positioned on a planter to detect if the seed container is correct compared to a prescription seeding map. In the case where the incorrect seed container and/or RF pills 100 are in close proximity to the planter, a warning can be provided to a user to ensure that desired seed is placed into the correct receptacle (e.g., planter box, bulk planter hopper, etc.). During the planting operation, RF pills 100 may be planted into the ground in the same way as normal seeds. As each RF pill 100 is planted into the ground, an RFID reader 202 on the planter row unit or seeding unit may identify and track the seed location using GPS information and time. In this regard, the system 200 and RF pills 100 may help to ensure traceability of seed from a seed company to the planting location. Further, in the case of highly accurate GPS-enabled planters, the system 200 and RF pills 100 allow one to track the specific RF pills 100 to the exact GPS coordinate for which that particular RF pill 100 was planted. This capability is particularly useful in the case of controlling the amount or quantity of GMO (genetically modified organisms) products to specific locations (e.g., countries) or other environmental concerns.

FIG. 2B illustrates a schematic view 230 of a dispensing unit including multiple hoppers 201a-201d, in accordance with one or more embodiments of the present disclosure. It is noted that during a certain periods of harvest operation, multiple crops might be harvested in the same day or over a short period of time. It is noted that multiple hoppers 201a-201d may be installed on a given agricultural machine 215 to minimize time required to switch from one RF pill type to another. For example, as shown in FIG. 2B, the individual hoppers 201a-201d may be installed on the same dispenser base 231, which is mechanically coupled to the agricultural machine 215 via the connection device 213.

FIG. 2C illustrates a block diagram view of system 200, in accordance with one or more embodiments of the present disclosure. In one embodiment, the system 200 includes the RF pill dispensing unit 201, RFID reader 202, controller 210 and remote server 220 for maintaining database 226.

In one embodiment, the RFID device 102 contained within a RF pill 100 is configured to transmit one or more signals 234 (e.g., electromagnetic RF signal) indicative of the informational characteristic of the associated RF pill 100. It is noted that the RFID device 102 may be configured for operation in passive mode (i.e., transmits in response to interrogation from reader 202) or in active mode (i.e., actively transmits signal).

RFID devices and their operation modes are generally described by Ahmed Toaha, Mobashsher, Mohammad Tariqul Islam and Norbahiah Misran in RFID Technology: Perspectives and Technical Considerations of Microstrip Antennas for Multi-Band RFID Reader Operation, Current Trends and Challenges in RFID, Prof. Cornel Turcu (Ed.), ISBN: 978-953-307-356-9, InTech (2011), which is incorporated herein by reference in the entirety.

In one embodiment, the RFID device 102 includes communication circuitry, such as one or more transmitters or transponders, configured to transmit one or more signals 234 encoded with information associated with the corresponding RF pill 100 such that the transmitted signal is indicative of the information characteristic associated with the given RF pill 100. In another embodiment, the RFID device 102 may include communication circuitry, such as one or more transmitters or transponders, configured to transmit a signal 234 at characteristic frequency, such that reader 202 may associate the signal transmitted at the characteristic frequency with specific type of RF pill 100 (e.g., corn, soybean, rice, wheat) or variety of RF pill 100 (e.g., corn variety 1, corn variety 2, corn variety 3 and so on).

In another embodiment, the reader 202 includes one or more processors 204 and communication circuitry. The communication circuitry may include any communication circuitry 206 known in the art of remote sensing and/or radio frequency identification. For example, the communication circuitry may include a transceiver 206 for transmitting an interrogating RF signal 236 via antenna 208 to the RFID device 102 embedded in a given RF pill 100. Further, the transceiver 206 may receive, in response to the interrogation signal 236, the signal 234 transmitted or reflected by the RFID device 102, which is encoded with the information characteristic associated with the RF pill 100. By way of another example, the communication circuitry may include a dedicated transmitter and receiver. For instance, the transmitter may transmit an interrogating RF signal 236 to the RFID device 102 embedded in a given RF pill 100. Further, the receiver may receive, in response to the interrogation signal 236, the signal 234 transmitted or reflected by the RFID device 102.

In another embodiment, the one or more processors 204 of the reader 202 may receive the signal received by the transceiver 206 and transmit (e.g., transmit via wireless or wireline connection) the associated information to controller 210. In one embodiment, the controller 210 includes one or more processors 212 and memory 214. It is noted that controller 210 may be embodied as, but is not limited to, a desktop computer, a laptop computer, a tablet device, a smartphone or a customized computing device (e.g., a computing device integrate within agricultural machine).

In another embodiment, the system 200 includes a global positioning receiver configured to receive global position information from a global position system (e.g., GPS, GNSS, GLONASS and the like). For example, GPS receiver 221 may be included in or near the controller 210. By way of another example, the GPS receiver 221 may be located on or near the dispensing unit 201 and is communicatively coupled to the controller 210 (e.g., via wireless or wireline connection). By way of another example, system 200 may utilize a GPS receiver 221 present in the agricultural machine 215 (e.g., combine). In this regard, the combine control systems may transmit the GPS information to the controller 210 (e.g., via wireless or wireline connection). In each case, the controller 210 may retrieve position information from the GPS receiver 221 at or near the same time a RF pill 100 is read by reader 202. In turn, the controller 210 may associate the collected GPS location from the GPS receiver 221 with the date/time (from controller clock) and the identification information (e.g., serial number) of the RF pill 100 received from the reader 202.

It is noted that the system 200 is not limited to the correlation of identification information with time/date and geographic location of the one or more RF pills 100. Rather, the system 200 may include one or more additional sensors (not shown) configured to measure one or more additional characteristics or parameters of the seed grain 207 and/or RF pills 100. In this regard, the system 200 may be extended to correlate any measured quantity associated with the seed grains 207 and/or RF pills 100 with the identification information of the RF pills 100. For example, the system 200 may associate sensor data acquired from one or more sensors with the identification information, time/date and/or GPS data of the one or more RF pills 100. The sensor information may then be transmitted from the one or more sensors to the controller 210, where the association as described throughout the present disclosure may be carried out. The one or more sensors may include any type of sensor used to characterize a physical state of one or more grain or agricultural settings. For example, the one or more sensors may include one or more of a temperature sensor, a moisture sensor and the like. In another embodiment, additional properties may be measured at the time of RF pill dispersal and saved into the database 226 and associated with the RF pills that are dispersed. For instance, additional properties may include, but are not limited to, protein level, foreign matter level and the etc.

In another embodiment, the controller 210 is communicatively coupled to control circuitry 219 of the RF pill dispensing unit 201. In this regard, the controller 210 may control the dispersal of the RF pills 100. For example, in response to a command signal from controller 210, the control circuitry 219 of the dispensing unit 201 may direct a controllable portion 205 (e.g., actuatable door or barrier, a vacuum and the like) of the hopper of the dispensing unit 201 to dispense (e.g., drop) one or more RF pills 100.

In another embodiment, the controller 210 is communicatively coupled to the remote server 220 via a network 218. In this regard, the controller 210 may include a network interface device 216 suitable for interfacing with network 218, while the remote server 220 includes a network interface device 217 also suitable for interfacing with network 218. The network interface devices 216 and 217 may include any network interface device known in the art. For instance, the network interface devices 216 and 217 may include wireline-based interface devices (e.g., DSL-based interconnection, Cable-based interconnection, T9-based interconnection, and the like). In another instance, the network interface devices 216 and 217 may include a wireless-based interface device employing GSM, GPRS, CDMA, EV-DO, EDGE, WiMAX, LTE, Wi-fi protocols, and the like.

In this regard, the controller 210 may transmit the results from reader 202 and/or GPS receiver 221 to a remote database 226 maintained in memory 224 of the remote server 220. In this sense, the system 200 may act to maintain the tracking information for each of the RF pills 100 in the “cloud” for later retrieval and analysis. For example, the remote database 226 may include, but is not limited to, one or more look up tables suitable for associating one or more characteristics of each of the RFIDs 102 with the corresponding RF pills 100.

In another embodiment, results from reader 202 and/or GPS receiver 221 may be stored in the local memory 214 of the controller 210. For example, in settings where controller 210 lacks connectivity to the remote server 220, the controller 210 may temporarily store results from the reader 202 in memory 214. Once connectively between the controller 210 and the remote server 220 is established the controller 210 may transmit the results stored in memory 214 to the database 226 of memory 224 of the remote server 220 via network 218.

In another embodiment, the reader 202 may be directly coupled to the remote server 220 via network 218. In this regard, the functions associated by controller 210 and reader 202 may be executed within one or more processors of a single unit. For example, the single reader/controller may include communication circuitry (e.g., transceiver 206), memory, one or more processors and a network interface device for coupling directly to network 218.

In another embodiment, the controller 210 may be disposed on board of the dispenser unit 201. In this regard, when a dispenser unit 201 is attached to an agricultural machine 215, the controller 210 located on board of the dispenser unit 201 may establish a communication link to the remote server 220 via a network connection. Further, the controller 210 (or reader 202 directly) may integrate with the various systems available on the agricultural machine 215 such as, but not limited to, the machine's telematics device, a user's smartphone, a field network and the like.

The one or more components of system 200 may be communicatively coupled to the various other components of system 200 in any manner known in the art. For example, the one or more processors 204, 212 and 222 may be communicatively coupled to each other and other components via a wireline (e.g., copper wire, fiber optic cable, and the like) or wireless connection (e.g., RF coupling, IR coupling, data network communication (e.g., WiFi, WiMax, Bluetooth and the like).

FIG. 2D illustrates system 200 configured in a local mode, in accordance with one or more additional embodiments of the present disclosure. In this embodiment, a local database 228 is used to track the identification information, date/time and/or location of the RF pills 100. In this regard, the local database 228 is maintained on the controller 210, which is positioned in proximity to the dispensing unit 201 and the dispersal site.

The one or more processors of the reader 202, controller 210 and/or remote server 220 may include any one or more processing elements known in the art. In general, the term “processor” may be broadly defined to encompass any device having one or more processing elements, which execute program instructions from a non-transitory memory medium. In one embodiment, the one or more processors 204, 212 and/or 222 may include any microprocessor-type computational device configured to execute software algorithms and/or instructions. The one or more processors 204, 212, and/or 222 may be embodied in, or consist of, a personal computer system, mainframe computer system, workstation, image computer, parallel processor, a networked computer or any other computational device known in the art. In general, the term “computational device” may be broadly defined to encompass any device having data processing or logic capabilities. It should be recognized that the steps described throughout the present disclosure may be carried out by a single controller or, alternatively, multiple controllers.

The memory 214 and/or 224 may include any storage medium known in the art suitable for storing program instructions executable by the associated one or more processors and/or for storing one or more databases 226 and/or 228. For example, the memory may include, but is not limited to, random access memory (RAM), read-only memory (ROM), or a persistent store, such as a mass storage device, hard drives, CDROM, DVDROM, tape, erasable programmable read-only memory (EPROM or flash memory), any magnetic, electromagnetic, solid state, infrared, optical, or electrical system, apparatus or device for storing information, or any other type of media suitable for storing electronic data.

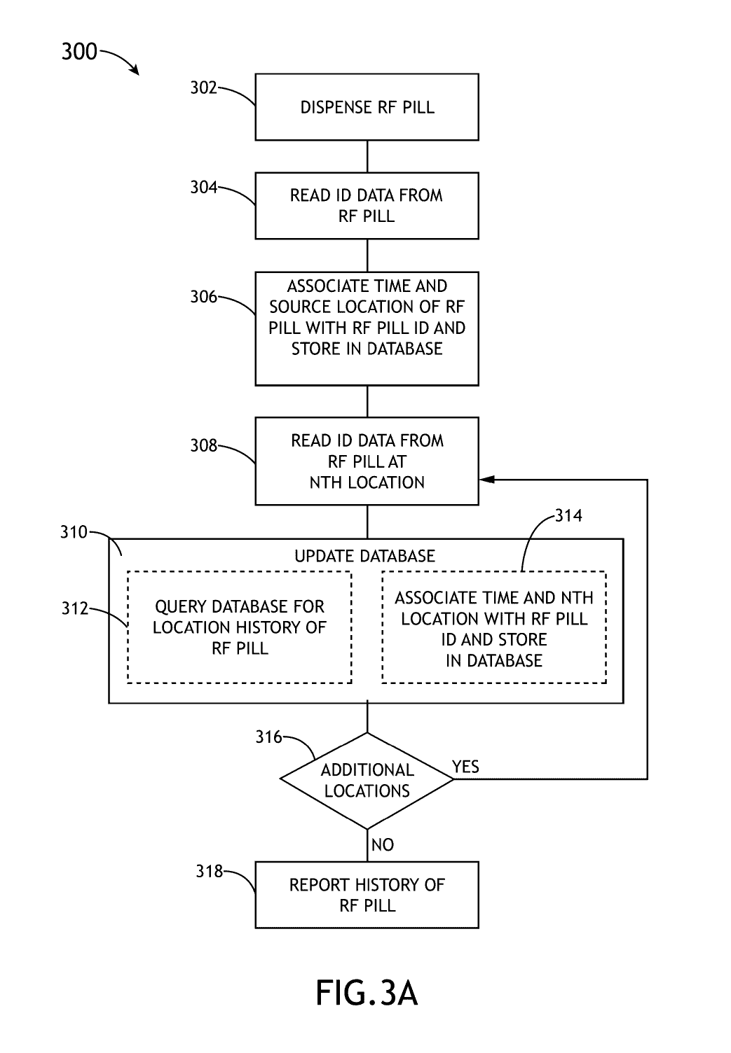

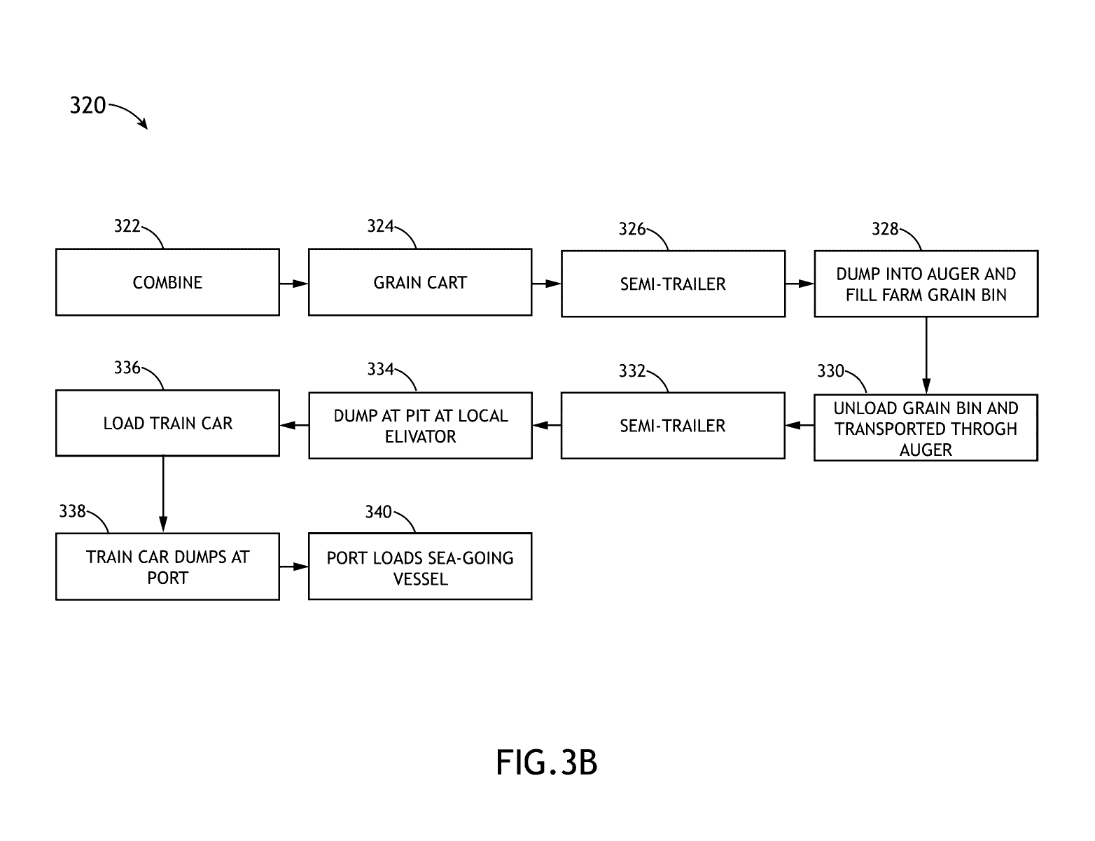

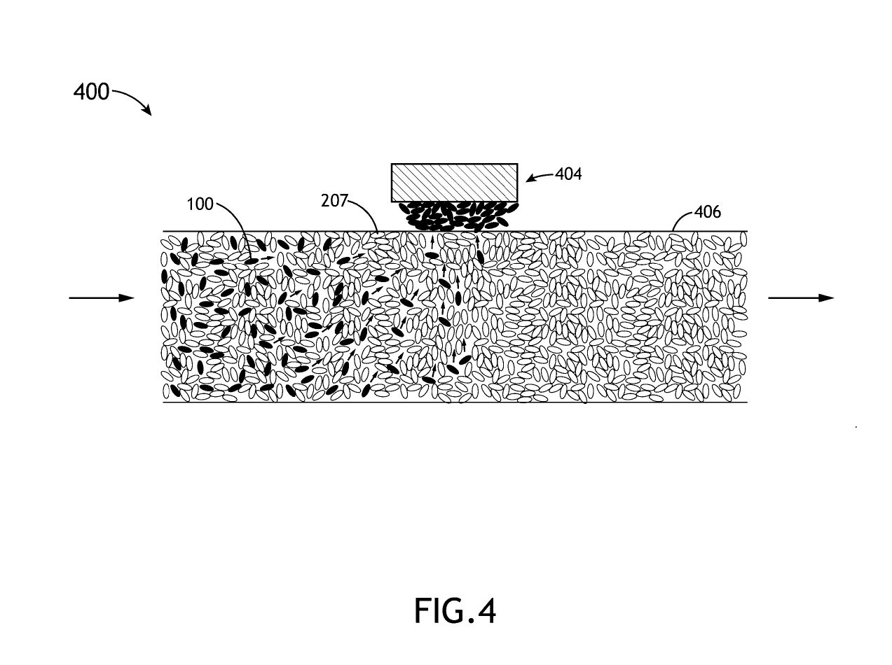

FIG. 3A illustrates a process flow diagram depicting a method 300 for tracking grain, in accordance with one or more embodiments of the present disclosure.

In step 302, one or more RF pills 100 are dispensed. For example, as shown in FIGS. 2A-2D, one or more RF pills 100 may be dispensed from the dispensing unit 201. For instance, controller 210 may direct control circuitry 219 of the dispensing unit 201 to release one or more RF pills 100. The controller 210 may base this command on a selected interval frequency of RF pill 100 release, distance traveled by the agricultural machine 215 or an anticipated or determined harvest yield.

In step 304, identification information is read from the one or more RF pills 100. For example, as shown in FIGS. 2A-2D, as the one or more RF pills 100 traverse the region near or within (in the case of an annular reader) the RFID reader 202, the identification information stored on the RFID 102 is read by the RFID reader 202. For example, in the case of passive operation, the reader 202 may transmit an interrogation signal 236, which is received by the RFID 102 and serves to activate the RFID 102. In turn, the RFID 102 transmits signal 234, which is encoded with the identification information stored on the RFID memory. By way of another example, the reader 202 and RFID 102 may operate in active mode, whereby the RFID 102 actively transmits a signal 234 encoded with the identification information of the RF pill 100 and the reader 202 receives the signal.

In step 306, the time and source location of the one or more dispensed RF pills 100 is associated with the corresponding RF pill identification information and stored in a database. For example, as shown in FIGS. 2A-2D, upon reading the RFID information from the RF pills 100, the transceiver 206 of the reader 202 may transmit the identification information to the one or more processors 204. In turn, the one or more processors 204 of the reader 202 may transmit an additional signal to the controller 210 via a wireless connection (e.g., network, WiFi, Bluetooth, Near Field and etc.) or wireline connection (e.g., network, copper line, optical fiber line and the like). At or near the same time, the controller 210 receives the identification information from the dispensed one or more RF pills 100, the controller 210 may also acquire geographical location information from GPS receiver 221. Further, the controller 210 may associated the identification information (e.g., serial number) of the dispensed one or more RF pills 100, the time/date of dispersal of the one or more RF pills 100 (from controller clock) and the geographical location of the dispersal of the one or more RF pills 100. In turn, this information may be stored in a remote database 226 (maintained in “cloud” on remote server 220) or local database 228 (maintained on local memory 214).

In step 308, the identification information is read from the one or more RF pills 100 at N locations. In this regard, steps 304 and 306 may be repeated for one or more RF pills 100 at additional locations throughout the value chain of the grain in question.

In step 310, sub-steps 312 and/or 314 may be executed. In sub-step 312, the database is queried for location history of one or more of the RF pills 100. In sub-step 314, time/date and location information are associated with identification information read in at the Nth location, which is then stored in memory. For example, once a particular RF pill 100 is read at the Nth location, the controller 210 may query the database 226 to determine if previous entries for that particular RF pill 100 are contained in the database 226. In the event no entries exist in the database 226, the controller 210 may execute step 314 to establish a new entry for the newly identified RF pill 100. In the case where historical entries do exist in the database 226, the controller may execute step 314 to update/append the database with the new time/date and location information of the particular RF pill 100.

In step 316, it is determined if RFID readings are to be taken at different locations. In the case where additional locations must be read then the method 300 moves back to step 308 and steps 308-316 are repeated. In the case where no additional measurements (i.e., grain to be tracked is at the end of the life cycle) are to be performed then the method 300 moves to step 318.

In step 318, the history of one or more RF pills 100 is reported. For example, the controller 210 may report the history of one or more RF pills 100 to a user via a display (not shown) communicatively coupled to the controller 210. By way of another example, the controller 210 may report the history of one or more RF pills 100 to memory (e.g., remote memory 224 or local memory 214 or another memory). By way of another example, the controller 210 may report the history of one or more RF pills 100 to an additional device communicatively coupled to the controller 210. The additional device may include a portable user device, such as, but not limited to, a smart phone, table, laptop and the like. Further, the controller 210 may report the history of the one or more RF pills 100 via remote serve 220. In this regard, multiple users may log into the server 220 (e.g., private access or via public service) to acquire the history of the RF pills 100 and, thus, the grain 207, which contained the RF pills 100.

The history of the RF pills 100 (and grain 207) may be reported individually or in aggregate form. In this regard, batches of RF pills 100 originally dispensed at or near the same location (e.g., same farming operation, same field, same portion of field and the like) may be aggregated and presented as one entity representative of the evolution of the grain 207 harvested as the same location. Additionally, the history of the one or more RF pills 100 may be reported individually so that the history for a single RF pill 100 may be displayed and viewed.

It is further noted that the history of one or more RF pills 100 (and grain 207) may be reported at any time during the grain's value chain and is the method is not limited to reporting historical information only after all N locations have been traversed.

It is noted that while the method of 300 focuses on the tracking of identification information, time/date and geographic location of the one or more RF pills 100, this is not a limitation of the present disclosure. Rather, the system 200 and method 300 may be extended to correlate any measured quantity associated with the seed grains 207 and/or RF pills 100 with the identification information of the RF pills 100. For example, the method of 300 may associate sensor data acquired from one or more sensors with the identification information of the one or more RF pills 100. For instance, one or more sensors may be used to measure one or more characteristics of the seed grain 207 and/or RF pills 100. The sensor information may then be transmitted from the one or more sensors to the controller 210, where the association as described above may be carried out. The one or more sensors may include any type of sensor used to characterize a physical state of one or more grain or agricultural settings. For example, the one or more sensors may include one or more of a temperature sensor, a moisture sensor and the like. In another embodiment, additional properties may be measured at the time of RF pill dispersal and saved into the database 226 and associated with the RF pills that are dispersed. For instance, additional properties may include, but are not limited to, protein level, foreign matter level and the etc.

FIG. 3B illustrates various steps through the agricultural value chain, in accordance with one or more embodiments of the present disclosure. For example, the system 200 may be used to read the one or more RF pills 100 at any one of the stages in the value chain 320. It is noted that the following steps are in no way a limitation on the scope of the present disclosure and are provided merely to illustrate one example of steps through an agriculture value chain. In step 322, the RF pills 100 and/or grain 207 are harvested by the combine. In step 324, the RF pills 100 and/or grain 207 are transferred from the combine to the grain cart. In step 326, the RF pills 100 and/or grain 207 are transferred from the grain cart (local to the field) to a semi-trailer. In step 328, the RF pills 100 and/or grain 207 are transferred from the semi-trailer and dumped into an auger and then fill a grain bin. In step 330, the RF pills 100 and/or grain 207 are unloaded from the grain bin and transported through the auger. In step 332, the RF pills 100 and/or grain 207 are transported through the auger to another semi-trailer. In step 334, the RF pills 100 and/or grain 207 are dumped out the semi-trailer at a pit at a local grain elevator. In step 336, the RF pills 100 and/or grain 207 are loaded onto a train car at the local elevator. In step 338, the RF pills 100 and/or grain 207 are dumped out the train care at a ship port. In step 340, the RF pills 100 and/or grain 207 are loaded onto a sea-going vessel, or ship, at the port.

It is noted that each of the above steps (and/or alternative steps) of the system 200 may read the RF pills 100 and track one or more characteristics (e.g., time/date, location, one or more sensor readings) associated with each of the identified RF pills 100. At each stage, the system 200 may update the database 226, which may be accessed at any time during the value chain to monitor the seed grain behavior (through the monitoring of the RF pills 100).

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, etc. Furthermore, the results may be stored “permanently,” “semi-permanently,” temporarily, or for some period of time. For example, the memory may be random access memory (RAM), and the results may not necessarily persist indefinitely in the memory.

At the end of the value chain or lifecycle of the seed grain 207, the RF seed pills 100 may be removed. It is noted that the RF pills 100 may be removed via any sorting process known in the art. For example, the RF pills 100 may be removed through a conveyor/gravity assist process. In this case, the RF pills 100 are deliberately fabricated to be heavier and/or smaller than the targeted seed grains 207. In this manner, as the mixture 211 of seed grains 207 and RF pills 100 is conveyed along the conveyer the RF pills 100 shift toward the bottom of the mixture, where they can be filtered off using filter and/or mesh larger than the RF pills 100, but smaller than the seed grains 207. In another embodiment, in cases where the RF pills 100 are lighter than the seed grain 207, a double conveyor system and blower unit may be utilized to “blow off” the RF pills 100 as the RF pills 100 fall from one conveyor to the next. In another embodiment, in cases where the RF pills 100 and the seed grain 207 have different masses, a centrifuging approach may be utilized.

In embodiments where the RF pills 100 and seed grains 207 have very similar mechanical properties, a magnetic removal unit may be utilized. In some cases, the RF pills 100 may be formed with or coated with a magnetic or magnetizable material. For instance, the RF pills 100 may be formed so the pill body 101 is formed with magnetic material (e.g., ferrous material) or magnetic nanoparticles (e.g., magnetic ceramic nanoparticles). Further, to avoid or reduce electromagnetic interference between the RFID 102 and the reader 202, the RF pills 100 may be only partially coated (e.g., coated at one end or on one half) with magnetic material or magnetic nanoparticles, so transmission between the RF pills 100 and the reader 202 remains adequate.

FIG. 4 illustrates conveyor system 400 for magnetically removing RF pills 100 from the seed grains 207, in accordance with one or more embodiments of the present disclosure. In one embodiment, the system 400 includes one or more magnets 400 (e.g., permanent magnets or electromagnets) disposed proximate to conveyor unit 406. In this regard, as the mixture 211 of seed grains 207 and magnetized RF pills 100 pass the one or more magnets the one or more magnets attract the magnetized RF pills 100 and remove them from the seed grains 207. The one or more magnets may be arranged in any manner relative to the conveyor unit 406. Further, several magnets may be arranged along the conveyor unit 406.

In another embodiment, the RF pills 100 may be selected colored. For example, the RF pills 100 may be color with a bright color so to enhance being detected by a user's vision or by electronic cameras.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device-detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although a user is shown/described herein as a single illustrated figure, those skilled in the art will appreciate that the user may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed:

1. A pill assembly
a body, the body having an outer surface shaped substantially the same as a selected seed type,
wherein the body includes a cavity;
a radio frequency identification device (RFID) disposed within the cavity of the body, wherein the RFID is encoded with identification information readable by a remotely positioned reader.

2. The pill assembly of claim 1, wherein the body is molded about the RFID.

3. The pill assembly of claim 1, wherein the body includes a first portion and at least a second portion, wherein the first portion and the at least a second portion are affixed together.

4. The pill assembly of claim 1, wherein the selected seed type comprises:
at least one of a corn seed, a soybean seed, a rice side or a wheat seed.

5. The pill assembly of claim 1, wherein the mass of the pill assembly is substantially the same as an average of the mass of multiple seeds of the selected seed type.

6. The pill assembly of claim 1, wherein the density of the pill assembly is substantially the same as an average of the density of multiple seeds of the selected seed type.

7. The pill assembly of claim 1, wherein the coefficient of friction of the pill assembly is substantially the same as an average of the coefficient of friction of multiple seeds of the selected seed type.

8. The pill assembly of claim 1, wherein the body is formed from at least one of an organic material, a metal material or a ceramic material.

9. The pill assembly of claim 1, wherein the body is formed from a biological material.

10. The pill assembly of claim 1, wherein the body includes at least one of a magnetic material or a magnetizable material.

11. The pill assembly of claim 1, wherein an outer surface of the body is selectively colored.

12. A pill assembly
a body, the body having an outer surface shaped substantially the same as a selected agricultural product,
wherein the body includes a cavity;
a radio frequency identification device (RFID) disposed within the cavity of the body, wherein the RFID is encoded with identification information readable by a remotely positioned reader.

13. The pill assembly of claim 12, wherein the selected agricultural product comprises:
at least one of a vegetable, a fruit, a melon or a tuber.

14. A system for tracking seeds comprising:
a radio frequency (RF) pill dispenser unit, wherein the RF pill dispenser unit is configured to dispense a plurality of RF pills into a volume of grain seeds, wherein each of the plurality of RF pills includes a radio frequency information device (RFID) encoded with identification information;
an RFID reader, wherein the RF pill dispenser unit is configured to transport the plurality of RF pills through a region at least proximate to the RFID reader, the RFID reader configured to identify at least some of the plurality of RF pills as the RF pills are transported through the region at least proximate to the RFID reader;
a database;
a controller communicatively coupled to the RFID reader, the controller including one or more processors configure to execute a set of program instructions maintained in memory, the set of program instructions configured to cause the one or more processors to:
acquire identification information for a particular RF pill from the RFID reader;
acquire time information corresponding to the time of identification of the particular RF pill;
receive GPS data corresponding to the geographical location of the RFID reader at the time of identification of the particular RF pill; and
store the identification information, the time information and geographical location information in the database.

15. The system of claim 14, wherein the controller is further configured to:
acquire identification information for the particular RF pill from the RFID reader at an additional time;
acquire the time information corresponding to the additional time of identification of the particular RF pill;
receive GPS data corresponding to the geographical location of the RFID reader at the additional time of identification of the particular RF pill; and
store the identification information, the time information and geographical location information in the database for the additional time.

16. The system of claim 14, wherein the controller is further configured to:
retrieve historical identification information, time information and geographical location information for one or more particular RF pills from the database; and
report the historical identification information, time information and geographical location information for one or more particular RF pills from the database

17. The system of claim 14, wherein the RF pill dispensing unit comprises:
one or more hoppers.

18. The system of claim 14, wherein the plurality of RF pills are transported sequentially according to a selected time interval.

19. The system of claim 14, further comprising:
a global position system (GPS) receiver.

20. A composition of matter comprising:
a plurality of radio frequency (RF) pills RF pills, wherein the plurality of RF pills are intermixed with a selected volume of a particulate matter.

21. The composition of matter of claim 20, wherein the volume of particular matter comprises a volume of a selected seed.

22. The composition of matter of claim 20, wherein the volume of the selected seed comprises a volume of at least one of corn seen, soybean seed, rice seed or wheat seed.

23. The composition of matter of claim 20, wherein the plurality of RF pills and the volume of particular matter are intermixed at a ratio between 1:10,000,000 and 1:5000 by particle number.
